(19) United States
(12) Patent Application Publication
(10) Pub. No.: US 2016/0304077 A1
(43) Pub. Date: Oct. 20, 2016

(54) HYBRID ELECTRONIC VEHICLE AND CONTROLLING METHOD THEREOF

(71) Applicant: Hyundai Motor Company, Seoul (KR)

(72) Inventors: Jeamun Lee, Seoul (KR); Jungsoo Park, Seoul (KR)

(21) Appl. No.: 14/948,680

(22) Filed: Nov. 23, 2015

(30) Foreign Application Priority Data
Apr. 20, 2015 (KR) 10-2015-0055511

(51) Int. Cl. B60W 20/00; B60K 6/442; B60H 1/00; B60W 10/06; B60W 10/08

(52) U.S. Cl. CPC B60W 20/00; B60W 10/06; B60W 10/08; B60H 1/00814; B60K 6/442; B60W 2710/0688; Y10S 903/93; B60Y 2200/92; B60Y 2300/182; B60Y 2300/43; B60Y 2300/60; B60Y 2300/91; B60Y 2300/51; B60Y 2306/05

(57) ABSTRACT

A hybrid vehicle is provided that includes a battery, a motor that is configured to generate a driving torque using the battery, and an engine that is configured to charge the battery or generate a driving torque together with the motor. A driving controller operates the motor and the engine and an air conditioning controller executes a heat function by a heat of an engine coolant and transmits an engine-drive-requiring signal to the driving controller to heat the engine coolant. When a first condition that a temperature of the engine coolant is greater than a first temperature and a second condition that a driving torque generated by the motor is sufficient to move the hybrid vehicle are satisfied, the engine operation is stopped by a time that a driving torque generated by the engine is required to move the hybrid vehicle regardless of receiving the engine-drive-requiring signal.

### CROSS-REFERENCE TO RELATED APPLICATION

This application claims priority to and the benefit of Korean Patent Application No. 10-2015-0055511 filed in the Korean Intellectual Property Office on Apr. 20, 2015, the entire contents of which are incorporated herein by reference.

### BACKGROUND

(a) Field of the Invention

The present invention is related to a hybrid vehicle and a control method thereof, and more particularly, to a hybrid vehicle and a control method thereof in which the engine coolant is heated more efficiently to improve fuel efficiency of the vehicle.

(b) Description of the Related Art

A hybrid vehicle uses a motor as well as an engine to gain a driving torque for driving a vehicle. A controller of the hybrid vehicle appropriately adjusts driving torques generated from a motor and an engine to drive a vehicle with improved fuel efficiency. The hybrid vehicle may provide a heating function to a user by using a heat of an engine coolant as an energy source. Accordingly, when a water temperature of an engine coolant is equal to or less than a predetermined level, a heating function satisfying a user requirement may be unavailable.

Additionally, when the water temperature of the engine coolant is equal to or less than the predetermined level, an air conditioning system mounted within a hybrid vehicle requests a driving controller to operate an engine for heating an engine coolant. However, when a driving controller operates an engine unconditionally based on the request, fuel efficiency may be deteriorated.

The above information disclosed in this section is merely for enhancement of understanding of the background of the invention and therefore it may contain information that does not form the prior art that is already known in this country to a person of ordinary skill in the art.

### SUMMARY

The present invention provides a hybrid vehicle and a control method thereof having advantages of an efficient heating of an engine coolant in an efficiency mode, thereby improving fuel efficiency.

An exemplary embodiment of the present invention provides a hybrid vehicle that may include a battery, a motor configured to generate a driving torque using the battery, an engine configured to charge the battery or generate a driving torque together with the motor, a driving control portion configured to operate the motor and the engine, and an air conditioning control portion configured to execute a heat function by heat of an engine coolant and transmit an engine-drive-requiring signal to the driving control portion to heat the engine coolant.

Further, when a first condition in which a temperature of the engine coolant is equal to or a first temperature and a second condition in which a driving torque generated by the motor is sufficient to move the hybrid vehicle are satisfied, the driving control portion, may stop operating the engine by a time that a driving torque generated by the engine is required to move the hybrid vehicle regardless of receiving the engine-drive-requiring signal. The driving control portion may be configured to operate the engine continuously to increase a temperature of the engine coolant to be equal to or greater than the first temperature when a temperature of the engine coolant is less than the first temperature. The hybrid vehicle may further include a mode-determining portion configured to determine a heating service mode based on a user setting and an exterior temperature.

The heating service mode may include a performance mode and an efficiency mode, and, when a third condition in which the heating service mode is the efficiency mode is further satisfied, the driving control portion may stop operating the engine by a time that a driving torque of the engine is required to move the hybrid vehicle regardless of receiving the engine-drive-requiring signal. When a temperature of the engine coolant is less than the first temperature, the driving control portion may be configured to continuously operate the engine to increase a temperature of the engine coolant to be equal to or greater than the first temperature, and the first temperature may have two different values in the performance mode and in the efficiency mode, respectively.

In addition, when an average time interval between movement and stop of the hybrid vehicle is equal to or less than a first time interval, the driving control portion may be configured to block charging of the battery by the engine based on the engine-drive-requiring signal. When the average time interval between the movement and the stop of the hybrid vehicle is greater than the first time interval, the driving control portion may allow the battery to be charged by the engine based on the engine-drive-requiring signal.

The user setting may include a driving mode setting, a temperature setting, and a wind strength setting, and the mode-determining portion may be configured to determine the heating service mode as the efficiency mode, when the driving mode setting is an ECO mode, the temperature setting is less than a maximum value, the wind strength setting is less than a maximum value, and a difference between an interior temperature of the hybrid vehicle and the exterior temperature is equal to or less than a predetermined range.

An exemplary embodiment of the present invention provides a controlling method of a hybrid vehicle that may include: transmitting an engine-drive-requiring signal to a driving control portion for heating an engine coolant; determining whether a first condition in which a temperature of the engine coolant is equal to or greater than a first temperature and a second condition in which a driving torque generated by a motor is sufficient to move the hybrid vehicle, are satisfied; and stopping a driving of an engine, when the first and second conditions are satisfied by a time that driving torque generated by the engine is required to move the hybrid vehicle regardless of receiving the engine-drive-requiring signal.

The controlling method of a hybrid vehicle may further include determining a heating service mode as a performance mode or an efficiency mode based on a user setting and an exterior temperature, and the driving control portion may stop driving the engine, when a third condition that the heating service mode is the efficiency mode, by a time that a driving torque generated by the engine is required to move the hybrid vehicle regardless of receiving the engine-drive-requiring signal. The controlling method of a hybrid vehicle may further include continuously operating the engine to increase the temperature of the engine coolant to be equal to or greater than the first temperature, when the temperature of the engine coolant is less than the first temperature.

The controlling method of a hybrid vehicle may further include preventing the driving control portion from charging a battery by the engine based on the engine-drive-requiring signal when an average time interval between movement and stop of the hybrid vehicle is equal to or less than a first time interval. Additionally, the controlling method of a hybrid vehicle may include allowing the driving control portion to charge the battery by the engine based on the engine-drive-requiring signal when the average time interval between the movement and the stop of the hybrid vehicle is greater than the first time interval.

According to an exemplary embodiment of the present invention, in the efficiency mode, by an efficient heating of the engine coolant engine coolant, a hybrid vehicle having improved fuel efficiency and a controlling method thereof may be provided.

### BRIEF DESCRIPTION OF THE DRAWINGS

Since the accompanying drawings are provided only to describe exemplary embodiments of the present invention, it is not to be interpreted that the spirit of the present invention is limited to the accompanying drawings.

FIG. 1 is a block diagram of a hybrid vehicle according to an exemplary embodiment of the present invention;

FIG. 2 is a control flowchart of a driving control portion according to an exemplary embodiment of the present invention; and

FIG. 3 is a graph representing a control of a driving control portion based on an average time interval between movement and stop of a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

In the drawings, the thicknesses of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

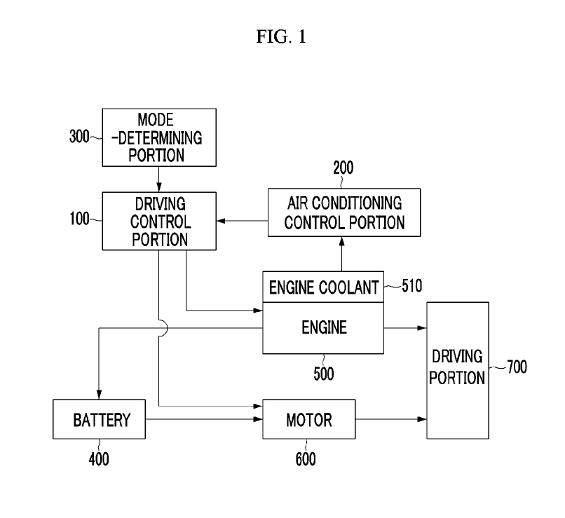

FIG. 1 is a block diagram of a hybrid vehicle according to an exemplary embodiment of the present invention. Referring to FIG. 1, a hybrid vehicle according to an exemplary embodiment of the present invention my include a driving control portion 100, an air conditioning control portion 200, a mode-determining portion 300, a battery 400, an engine 500, an engine coolant 510, a motor 600, and a driving portion 700. The various components of the vehicle may be operated by a controller (e.g., a central controller, an upper controller, etc.) having a processor and a memory. FIG. 1 illustrates only constituent elements in a hybrid vehicle as a block to describe an exemplary embodiment of the present invention. Therefore, a person of an ordinary skill in the art may use the present invention by inserting other constituent elements such as a regenerating control portion, a battery control portion, and the like.

The battery 400 is a vehicular battery and operates as a power source to drive a vehicle. The battery 400 is chargeable and dischargeable, and may be charged by driving the engine 500 and by driving the motor 600. When a stage of charge (SOC) reaches a fully charged state, the battery 400 may be operated not to be charged despite the driving of the engine 500, that is, the battery may be maintained at a current charged state to prevent over-charging. The motor 600 may be configured to generate a driving torque using the battery 400 as a power source. Such a driving torque may be delivered to the driving portion 700 to move a vehicle. The driving portion 700 may include a power delivery device, a transmission, a wheel, and the like to move a vehicle. The engine 500 may be configured to charge the battery 400 or generate a driving torque along with the motor 600. The engine 500 may be a gasoline engine, a diesel engine, or the like using a fossil fuel as a power source.

Depending on a connecting configuration of the engine 500, the battery 400, and the driving portion 700, a hybrid vehicle may be categorized into a series type, a parallel type, a series and parallel type, or the like. In a series type, the engine 500 may be configured to charge the battery 400 without connecting to the driving portion 700, and the motor 600 may be driven by energy of the battery 400 and may be configured to deliver a driving torque to the driving portion 700. In a parallel type, the engine 500 and the motor 600 may be configured to generate a driving torque and deliver a driving torque to the driving portion 700. In a series and parallel type, a mode may be selected appropriately between a series type mode of charging the battery 400 by the engine 500 and of generating a driving torque by the motor 600 using energy of the battery 400, and a parallel type mode of generating a driving torque by the engine 500 and the motor 600, and delivering a driving torque to the driving portion 700.

The present exemplary embodiment illustrated in FIG. 1 is related to a hybrid vehicle of a series and parallel type. In general, the hybrid vehicle of the series and parallel type generates a driving torque mainly by the motor 600 in a middle or low speed, and generates a driving torque mainly by the engine 500 in a high speed. When a driving torque is generated by the motor 600 and when a charging of the battery 400 is not required, the engine 500 may enter into a series type mode but may enter into a resting mode, to reduce fuel consumption. Herein, when that heating of the engine coolant 510 is required for a heating service and when the engine 500 is driven unconditionally, the engine 500 may be unable to charge the battery 400 and unable to deliver a driving torque, causing inefficient fuel consumption. Hence, it may be a problem that a hybrid vehicle may enter into neither a series type mode nor a parallel type mode, but may enter into an inefficient series type mode.

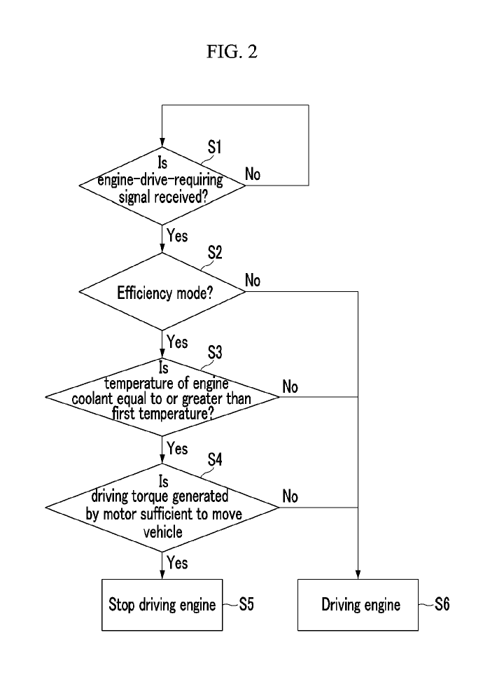

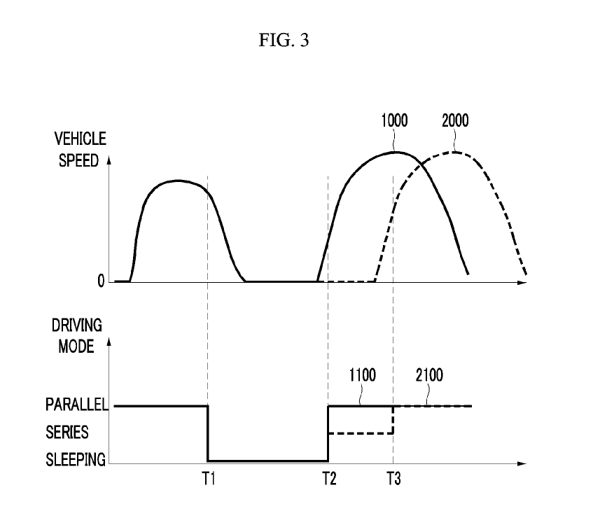

In FIGS. 2 and 3, a controlling method to solve such a problem will be described in detail. The driving control portion 100 may be configured to operate the motor 600 and the engine 500. The driving control portion 100 may be configured integrally with or separately from other controllers, and may be implemented by a hardware or a software. The driving control portion 100 (e.g., a controller or driving controller) may be configured to determine whether to use the motor 600 and/or the engine 500 as a power source, by detecting a current vehicle speed, and may be configured to adjust a speed of the vehicle. The driving control portion 100 may be configured to receive a current heating service mode from the mode-determining portion 300. and an engine-drive-requiring signal from the air conditioning control portion 200 (e.g., air conditioning controller) to heat the engine coolant 510. The driving control portion 100 of the present exemplary embodiment may be configured to selectively drive the engine 500 when the engine-drive-requiring signal is received.

The air conditioning control portion 200 may be configured execute a heating function of a vehicle using a heat of the engine coolant 510. When the heat of the engine coolant 510 is insufficient for a heating a vehicle, the air conditioning control portion 200 may be configured to deliver the engine-drive-requiring signal to the driving control portion 100. In response to receiving the signal, the air conditioning control portion 200 may be configured to detect an interior temperature and an exterior temperature of a vehicle from an interior temperature sensor and an exterior temperature sensor. The air conditioning control portion 200 may be a full automatic temperature controller (FATC).

The mode-determining portion 300 may be configured to determine a heating service mode based on a user setting and an exterior temperature. Such a heating service mode may include a performance mode and an efficiency mode. The user setting may include any user controlling settings in driving or air conditioning such as a driving mode setting, a temperature setting, a wind strength setting, and the like. The mode-determining portion 300 may be configured to determine the efficiency mode as the heating service mode, when the driving mode setting is a ECO mode, the temperature setting is less than a maximum value, the wind strength (e.g., of a blower) setting is less than a maximum value, and a temperature difference between interior and exterior temperatures of a vehicle is equal to or less than a predetermined range. Alternately, the temperature difference between the interior and exterior temperatures of the vehicle may be equal to or greater than the predetermined range. When the heating service mode is not determined as the efficiency mode, is the heating service mode may be determined as the performance mode.

FIG. 2 is a control flowchart of a driving control portion according to an exemplary embodiment of the present invention. FIG. 2 illustrates a control step based on the engine-drive-requiring signal of the air conditioning control portion 200 as a part of an entire control step instead of illustrating an entire control step of the driving control portion 100. The driving control portion 100 may be configured to receive the engine-drive-requiring signal from the air conditioning control portion 200 at step S1.

Further, the driving control portion 100 may be configured to detect that a current heating service mode is determined as the performance mode or the efficiency mode at step S2. In step S2, the driving control portion 100 may be configured to receive a heating service mode from the mode-determining portion 300. Alternately, the driving control portion 100 may be configured to receive the heating service mode periodically, regardless of the present step. In other words, when the driving control portion 100 receives a heating service mode, a time sequence is not limited to the present exemplary embodiment. When a current heating service mode is determined as the performance mode, the driving control portion 100 may perform no further determination and may be configured to operate the engine 500 in response to a request of the air conditioning control portion 200 at step S6.

When the current heating service mode is determined as the efficiency mode, the driving control portion 100 may be configured to detect whether a temperature of the engine coolant 510 is equal to or greater than a first temperature at step S3. The first temperature may be a minimum temperature of the engine coolant 510. This minimum temperature may vary based on a user, but the first temperature may be determined by a statistical average according to a survey. Such a first temperature may be a temperature in a range of about 50° F. to about 60° F.

Furthermore, the first temperature may be determined differently in the performance mode and in the efficiency mode. For example, in the efficiency mode, the first temperature may be determined to be about 50° F. and in the performance mode, the first temperature may be determined to about 55° F. In other words, the first temperature may be designed, with an assumption that a deterioration of a heating service performance is acceptable when a user prefers fuel efficiency. When a detected temperature of the engine coolant 510 is equal to or less than the first temperature, the driving control portion 100 may be configured to operate the engine 500 regardless of whether the current heating service mode is determined as the efficiency mode or the performance mode at step S6. When the detected temperature of the engine coolant 510 is equal to or greater than the first temperature, the driving control portion 100 enters into step S4.

The driving control portion 100 may then be configured to determine whether a driving torque generated by the motor 600 is sufficient to move a vehicle at step S4. In other words, in an uphill road or in a high speed driving, a driving torque generated by the motor 600 may be insufficient or inefficient. Particularly, the driving control portion 100 may be configured to operate the engine 500 at step S6. However, when the driving torque generated by the motor 600 is sufficient or efficient in a downhill road, in a low speed driving, or the like, the driving control portion 100 may enter into step S5 and stop operating the engine 500.

As a result, a hybrid vehicle according to an exemplary embodiment of the present invention, driving of the engine 500 may be stopped by a time that a driving torque generated by the engine 500 is required to move a vehicle regardless to whether the engine-drive-requiring signal is received. In other words, the engine 500 may be operated selectively, based on the engine-drive-requiring signal transmitted by the air conditioning control portion 200.

Herein, a time that the driving torque generated by the engine 500 is required to move a vehicle may be described by an exemplary embodiment illustrated in FIG. 3 as well as the above descriptions in step S4. In the hybrid vehicle of the series and parallel type, or the parallel type, a time that the driving torque generated by the engine 500 is required to move a vehicle may vary based on a vehicle, a traffic condition, or a road condition. Step S2, step S3, and step S4 may be executed reversely in a time sequence or simultaneously. In other words, when one condition is unsatisfied, the method may enter into step S6 to operate the engine 500, so a sequence of step S2, step S3, and step S4 may be designed differently according to a manufacturer.

FIG. 3 is a chart illustrating a control of a driving control portion based on an average time interval between movement and stop of a vehicle. As described above, various exemplary situations may be assumed to use a driving torque of the engine 500 and the motor 600 with efficient fuel consumption. Among them, FIG. 3 draws an exemplary comparison of two cases that an average time interval between movement and stop of a vehicle is relatively long, and the average time interval is relatively short.

A first case that the average time interval between the movement and the stop of the vehicle is relatively short may be expressed as being equal to or less than a first time interval, and a second case that the average time interval between the movement and the stop of the vehicle is relatively long may be represented as exceeding the first time interval. The first time interval may not be a particular time interval but a range of a time interval. For example, the first case in which the average time interval between the movement and the stop of the vehicle is equal to or less than the first time interval, may be driving a vehicle on a city street (e.g., an area having greater traffic congestion). Further, the second case in which the average time interval between the movement and the stop of the vehicle is greater the first time interval, may be driving a vehicle on a highway (e.g., minimal traffic congestion). Accordingly, this first time interval may vary based on a country, a region, or a usage of a vehicle.

Referring to FIG. 3, an upper curve represents a vehicle speed and a lower curve represents a driving mode of the engine 500 based on a vehicle speed. The first case in which the average time interval between the movement and the stop of the vehicle is equal to or less than the first time interval is drawn in curves 1000 and 1100, and the second case in which the average time interval between the movement and the stop of the vehicle is greater the first time interval is drawn in curves 2000 and 2100. When a vehicle speed is close to 0, a vehicle may be considered to be in a stop state. When a vehicle speed is greater than 0, a vehicle may be determined to be in a moving state.

In an exemplary situation of FIG. 3, a user may rapidly decrease a vehicle speed from around time T1 to stop a vehicle (e.g., a brake pedal may be rapidly engaged). A hybrid vehicle in a moving state is in the parallel type mode of delivering driving torques of the motor 600 and the engine 500 to the driving portion 700. However, by detecting a vehicle speed and a decreasing tendency thereof around time T1, the engine 500 may enter into a sleeping mode and the motor 600 may deliver a driving torque to the driving portion 700. Referring to curves 1000 and 1100, a user increases a vehicle speed again from around time T2 to move a vehicle (e.g., an acceleration pedal is engaged). Herein, a hybrid vehicle may be configured to operate the engine 500 from around time T2 by around time T2 the engine 500 is in a resting mode and enter into the parallel type mode along with the motor 600.

Thus, when an average time interval between movement and stop of a vehicle is minimal, the driving control portion 100 may not allow the engine 500 to be driven even though the engine-drive-requiring signal is received from the air conditioning control portion 200. In other words, since the average time interval between the movement and the stop of the vehicle is minimal, the movement may be expected in a short time, thus, driving the engine 500 during a short stopping interval may be hardly necessary. Accordingly, unless a temperature of the engine coolant 510 is equal to or less than the first temperature, it may be considered that a user does not feel uncomfortable to a heating service of a vehicle, and thus, the engine 500 may stop driving for a maximum time period.

Referring to curves 2000 and 2100, the user may increase the vehicle speed again from around time T3 to move a vehicle (e.g., further engaged the accelerator pedal). Herein, a hybrid vehicle may be configured to change the engine 500 into the series type mode around time T2 and change the engine 500 again into the parallel type mode around time T3. Thus, when the average time interval between the movement and the stop of the vehicle is long (e.g., greater than a predetermined time interval), when the engine-drive-requiring signal is received from the air conditioning control portion 200, the driving control portion 100 may allow the engine 500 to be driven.

In other words, the longer a vehicle stops, the more likely a temperature of the engine coolant 510 is equal to or less than the first temperature, so driving the engine 500 may be necessary to prevent a user from feeling uncomfortable to a heating service. Particularly, since the vehicle is in a stopping state, the parallel type mode may not be shifted. Accordingly, the vehicle may enter into the series type mode of charging the battery 400 while charging the battery 400 and heating the engine coolant 510.

The above detailed descriptions with reference to the accompanying drawings are provided to assist in comprehensive understanding of exemplary embodiment of the invention as defined by the claims and their equivalents. It includes various specific details to assist in that understanding but these are to be regarded as merely exemplary. Accordingly, those of ordinary skill in the art will recognize that various changes and modifications of the exemplary embodiments described herein can be made without departing from the scope and spirit of the invention. Therefore, the scope of the present invention shall be determined only according to the attached claims and the equivalents thereof.

### DESCRIPTION OF SYMBOLS

100: driving control portion

200: air conditioning control portion

300: mode-determining portion

400: battery

500: engine

510: engine coolant

600: motor

700: driving portion

What is claimed is:

1. A hybrid vehicle, comprising:
a battery;
a motor configured to generate a driving torque by using the battery;
an engine configured to charge the battery or generate a driving torque together with the motor;
a driving controller configured to operate the motor and the engine; and
an air conditioning controller configured to execute a heat function by a heat of an engine coolant and transmit an engine-drive-requiring signal to the driving controller to heat the engine coolant,
wherein, when a first condition in which a temperature of the engine coolant is equal to or greater than a first temperature and a second condition in which a driving torque generated by the motor is sufficient to move the hybrid vehicle are satisfied, the driving controller is configured to stop operating the engine by a time that a driving torque generated by the engine is required to move the hybrid vehicle regardless of receiving the engine-drive-requiring signal.

2. The hybrid vehicle of claim 1, wherein when a temperature of the engine coolant is less the first temperature, the driving controller is configured to operate the engine continuously to increase a temperature of the engine coolant to be equal to or greater than the first temperature.

3. The hybrid vehicle of claim 1 further comprising:
a mode-determining portion configured to determine a heating service mode based on a user setting and an exterior temperature,
wherein the heating service mode includes a performance mode and an efficiency mode, and
wherein when a third condition in which the heating service mode is the efficiency mode is satisfied, the driving controller is configured to stop operating the engine by a time that a driving torque of the engine is required to move the hybrid vehicle regardless of receiving the engine-drive-requiring signal.

4. The hybrid vehicle of claim 3, wherein when a temperature of the engine coolant is less than the first temperature, the driving controller is configured to continuously operate the engine to increase a temperature of the engine coolant to be equal to or greater than the first temperature, wherein the first temperature has two different values in the performance mode and in the efficiency mode, respectively.

5. The hybrid vehicle of claim 1, wherein when an average time interval between movement and stop of the hybrid vehicle is equal to or less than a first time interval, the driving controller is configured to block charging of the battery by the engine based on the engine-drive-requiring signal.

6. The hybrid vehicle of claim 5, wherein when the average time interval between the movement and the stop of the hybrid vehicle is greater than the first time interval, the driving controller is configured to charge the battery by the engine based on the engine-drive-requiring signal.

7. The hybrid vehicle of claim 3, wherein the user setting includes a driving mode setting, a temperature setting, and a wind strength setting, and the mode-determining portion is configured to determine the heating service mode as the efficiency mode when the driving mode setting is an ECO mode, the temperature setting is less than a maximum value, the wind strength setting is less than a maximum value, and a difference between an interior temperature of the hybrid vehicle and the exterior temperature is equal to or less than a predetermined range.

8. A controlling method of a hybrid vehicle, comprising:
receiving, by a controller, an engine-drive-requiring signal from an air-conditioning controller for heating an engine coolant;
determining, by the controller, whether a first condition in which a temperature of the engine coolant is equal or to greater than a first temperature and a second condition in which a driving torque generated by a motor is sufficient to move the hybrid vehicle are satisfied; and
stopping, by the controller, operation of an engine when the first and second conditions are satisfied, by a time that a driving torque generated by the engine is required to move the hybrid vehicle regardless of receiving the engine-drive-requiring signal.

9. The controlling method of a hybrid vehicle of claim 8, further comprising:
determining, by the controller, a heating service mode as a performance mode or an efficiency mode based on a user setting and an exterior temperature; and
stopping, by the controller, the operation of the engine, when a third condition in which the heating service mode is the efficiency mode is satisfied, by a time that a driving torque generated by the engine is required to move the hybrid vehicle regardless of receiving the engine-drive-requiring signal.

10. The controlling method of a hybrid vehicle of claim 9 further comprising:
operating, by the controller, the engine continuously to increase the temperature of the engine coolant to be equal to or greater than the first temperature when the temperature of the engine coolant is less than the first temperature.

11. The controlling method of a hybrid vehicle of claim 10 further comprising:
blocking, by the controller, charging of a battery by the engine based on the engine-drive-requiring signal when an average time interval between movement and stop of the hybrid vehicle is equal to or less than a first time interval.

12. The controlling method of a hybrid vehicle of claim 11 further comprising:
charging, by the controller, the battery by the engine based on the engine-drive-requiring signal when the average time interval between the movement and the stop of the hybrid vehicle is greater than the first time interval.

13. A non-transitory computer readable medium containing program instructions executed by a controller, the computer readable medium comprising:
program instructions that receive an engine-drive-requiring signal from an air-conditioning controller for heating an engine coolant;
program instructions that determine whether a first condition in which a temperature of the engine coolant is equal or to greater than a first temperature and a second condition in which a driving torque generated by a motor is sufficient to move the hybrid vehicle are satisfied; and
program instructions that stop operation of an engine when the first and second conditions are satisfied, by a time that a driving torque generated by the engine is required to move the hybrid vehicle regardless of receiving the engine-drive-requiring signal.

14. The non-transitory computer readable medium of claim 13, further comprising:
program instructions that determine a heating service mode as a performance mode or an efficiency mode based on a user setting and an exterior temperature; and
program instructions that stop the operation of the engine, when a third condition in which the heating service mode is the efficiency mode is satisfied ,by a time that a driving torque generated by the engine is required to move the hybrid vehicle regardless of receiving the engine-drive-requiring signal.

15. The non-transitory computer readable medium of claim 14, further comprising:
program instructions that operate the engine continuously to increase the temperature of the engine coolant to be equal to or greater than the first temperature when the temperature of the engine coolant is less than the first temperature.

16. The non-transitory computer readable medium of claim 15, further comprising:
program instructions that block charging of a battery by the engine based on the engine-drive-requiring signal when an average time interval between movement and stop of the hybrid vehicle is equal to or less than a first time interval.

17. The non-transitory computer readable medium of claim 16, further comprising:
program instructions that charge the battery by the engine based on the engine-drive-requiring signal when the average time interval between the movement and the stop of the hybrid vehicle is greater than the first time interval.
